(19) United States
(12) Patent Application Publication
(10) Pub. No.: US 2007/0169153 A1
(43) Pub. Date: Jul. 19, 2007

(54) Embeded USB interface circuit in AV device for recording programs

(75) Inventor: Jun Zhang, ShenZhen City (CN)

Correspondence Address: RABIN & BERDO, P.C., Suite 500, 1101 14th Street, N.W., Washington, DC, 20005, US

(73) Assignee: REALFINE (SHENZHEN) ELECTRONICS CO., LTD., ShenZhen City (CN)

(21) Appl. No.: 11/333,216

(22) Filed: Jan. 18, 2006

(51) Int. Cl. H04N 7/18

(52) U.S. Cl. 725/80; 725/74; 725/78

(57) ABSTRACT

A USB interface circuit achieves shared use of tuner, demodulator, IR receiving and achieves recording functions of AV device by providing a simple and general interface; this invention includes AV signals conversion module, communication control switch module, power switch module, USB interface controller, and USB interface; the obvious features of this invention are to achieve interface between TV set and external recording device by using simple structure, and the AV signals conversion module to achieve analog to digital conversion signals and speed rate matching of digital signals.

### BACKGROUND OF THE INVENTION

(a) Field of the Invention

The present invention is related to a circuit that process audio and video signals, and more particularly to a USB( universal serial bus) interface circuit that makes tuner, demodulator shared use between this USB interface circuit and audio or video devices such as TV set, Set Top Box etc., that makes an audio and video device with recording functions. (in the following description we will call an audio and video device as an AV device, a Set Top Box as STB).

(b) Background of Technology:

AV devices, e.g., TV sets (analog TV set or digital TV set) or STB generally available in the market can only process and play AV signals. It needs an external recording unit to store the contents received; and the TV set, STB or other devices usually have not USB interface. Therefore, it will cost much if adding the number of external recording unit during the recording procedure. Furthermore, taking advantage of a computer as a device to capture, record and play AV signals which proves to be a cheaper option, the AV device such as the TV set or the STB without USB interface becomes the bottleneck to achieve capturing and recording and playing AV signals.

### SUMMARY OF THE INVENTION

The primary purpose of the present invention is to provide a USB interface circuit which is embedded in AV device to overcome the flaw found in present technology. The circuit of the present invention expands the functions of AV devices such as TV set or STB, and makes AV devices to supply an USB interface for external recording unit such as a PC to record analog or digital AV signals received.

To achieve the purpose, the present invention supplies an AV process USB interface that makes tuner, demodulator shared use between this USB interface circuit and an AV device, and this USB interface circuit of AV device includes AV signals conversion module, communication control switch module, power switch module, USB interface controller module, and USB interface etc. Wherein, the AV signals conversion module is electrically connected to the USB controller so to convert analog or digital AV signals into digital AV signals with a matching speed rate that can be identified by the USB controller.

The power switch module is electrically connected to the USB controller so to receive controller signals from the USB controller; and it is also electrically connected to the USB interface and the power source module in the TV set or STB. The power source is from a primary AV device or from an USB interface from an external unit such as a PC etc., the power source is selected by control signal from USB controller, and the power source is used to supply power to an IR remote control receiving module, and a tuner/demodulator module in the TV set or STB.

The communication control switch module is electrically connected to the USB controller and the primary control module in the TV set or the STB; the selection signal is from the USB controller, it is used to select control signals coming from the USB controller or from the primary control module in primary TV set or STB, the control signals is used to control the tuner/demodulator module in primary TV set or STB.

The USB controller is electrically connected to the AV signals conversion module and the USB interface respectively so to receive digital AV signals from the AV signals conversion module, and transmit the signals to the USB interface; and the USB controller is further electrically connected to the IR remote-control receiving module for receiving remote-control signals.

The USB interface is electrically connected to the USB controller module and the AV signals conversion module so to provide a power source for all modiles and to provide an interface for an external unit.

Furthermore, the USB interface circuit of the present invention includes a memory module which is electrically connected to the USB controller for storing configuration information being read by the USB controller.

Accordingly, the following benefits are provided by the present invention: firstly, that a simple structure achieves interfacing between a TV set and an external recording unit; secondly, that the AV signals conversion module achieves digital signals converted from analog signals and digital signals speed rate matching; thirdly, that design method of module structure of the present invention permits combination as desired by the user for cost saving purpose, for example, we can omit memory module if we store the configuration information in an external personal computer, this will decrease cost; fourthly, that the present invention does not affect the existing operation functions of the AV device (e.g., TV set or STB); fifthly, that the present invention achieves shared tuner in the AV device; and sixthly, that the present invention can work with the AV device no matter whether power is on or off.

### BRIEF DESCRIPTION OF THE DRAWINGS

FIG. 1 is a block chart showing working theory of a process circuit of the present invention in a device of TV set or STB

FIG. 2 is a wiring diagram of a first preferred embodiment of the present invention.

FIG. 3 is a wiring diagram of a second preferred embodiment of the present invention.

### DETAILED DESCRIPTION OF THE PREFERRED EMBODIMENTS

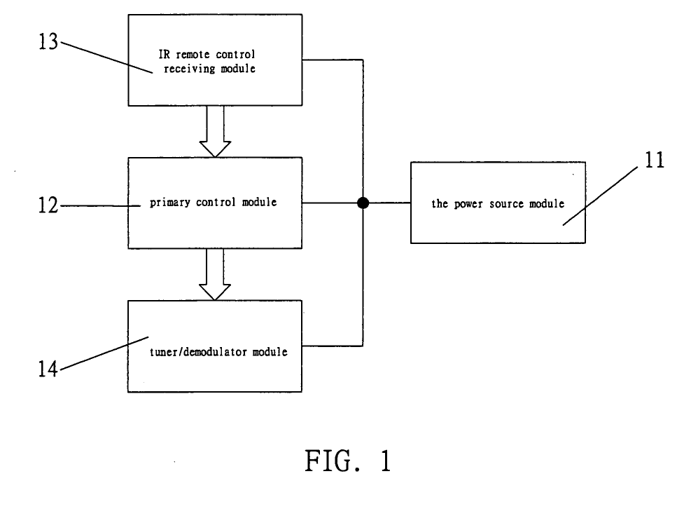

Referring to FIG. 1, a device 1 such as a TV set or a STB is essentially comprised of a power source module 11, a primary control module 12, a IR remote control receiving module 13, and a tuner/demodulator module 14. Wherein, the power source module 11 is electrically connected to the primary control module 12, the IR remote-control receiving module 13 and the tuner/demodulator module 14; the IR remote-control receiving module 13 receives infrared control signals and in turn transmit them to the primary control module 12; the primary control module 12 sends control signals to the tuner/demodulator module 14 and the tuner/demodulator module 14 outputs corresponding analog or digital AV signals.

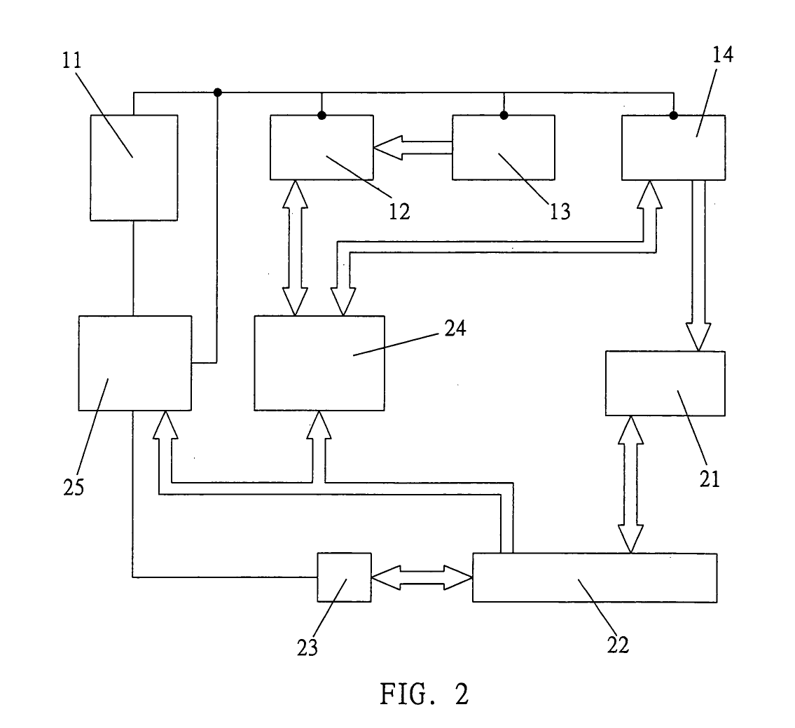

Now referring to FIGS. 2, for a USB interface circuit of a first preferred embodiment of the present invention to achieve shared tuner and AV device recording function, the USB interface circuit includes an AV signals conversion module 21, a USB controller 22, a USB socket 23, a communication control switch module 24, and a power source switch module 251. Wherein, the AV signals conversion module 21 is electrically connected to the USB controller 22 so to be transmitted the converted signals to the USB controller; and further being transmitted to an external device through the USB socket 23 which is connected to the USB controller 22; and the AV signals conversion module 21 is also electrically connected to the tuner/demodulator module 14 so to receive AV signals from the tuner/demodulator module 14. The AV signals may be analog or digital signals. In case of analog signals, the AV signals conversion module 21 executes analog to digital conversion and speed rate matching; and in case of digital signals, module 21 only executes speed rate matching.

The communication control switch module 24 includes a control port, two input ports and one output port. The control port is electrically connected to the USB controller 22. Two input ports are respectively electrically connected to the USB controller 22 and the primary control module 12 in the TV set or STB. The output port is electrically connected to the tuner/demodulator module 14; the two input control signals is selected from the USB controller or the primary control module for the tuner/demodulator module 14 by USB controller 22.

The power source switch module 251 includes a control port, two input ports, and an output port. The control port is electrically connected to the USB controller 22; one input port is directly connected to the USB interface 23, and another input port is electrically connected to the power source module 11 in the TV set or STB so to switch between two power sources that supply power to the IR remote-control receiving module, the primary control module and the tuner/demodulator module in the TV set or STB; thus the present invention achieves the purpose of shared use of the IR remote-control receiving module 13 and the tuner/demodulator module 14 when the TV set or the STB is powered on or off.

The USB controller 22 is also electrically connected to the IR remote-control receiving module 13 to receive IR remote control signals.

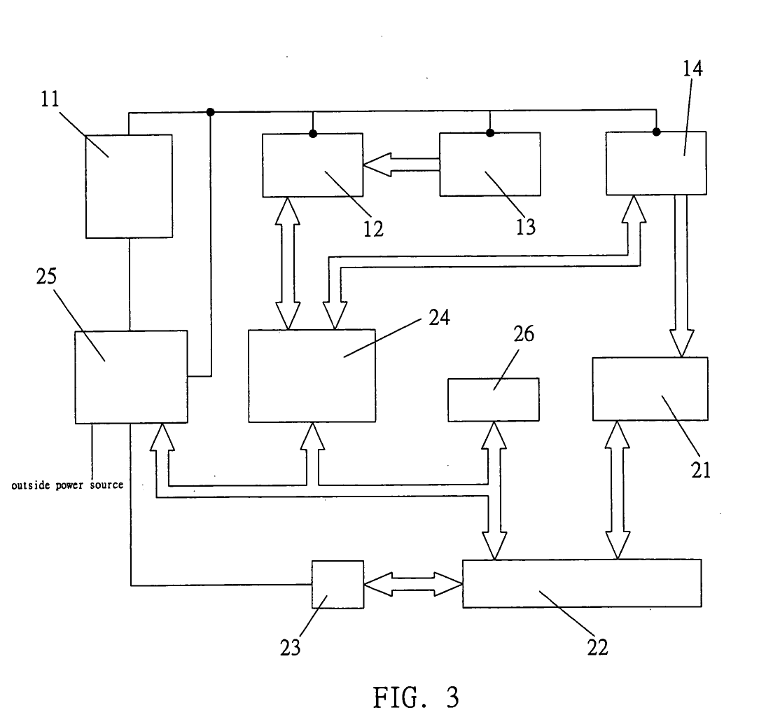

As illustrated in FIG. 3 for a second preferred embodiment of the present invention, to achieve the purpose of shared use of tuner/demodulator and to achieve recording function of AV device, a USB interface circuit includes the AV signals conversion module 21, the USB controller 22, the USB socket 23, a communication control switch module 24, a power source switch module 252, and a memory module 26. Wherein, the power source switch module 252 includes a control port, three input ports, and one output ports. The control ports is electrically connected to the USB controller, one input port is directly connected to the USB interface, another input port is connected to the power source input of an external device, and another input port is electrically connected to the power source module in the TV set or the STB so to switch between the two power sources that supply power to the IR remote-control receiving module, the primary control module and the tuner/demodulator module in the TV set or the STB.

The memory module 26 is electrically connected to the USB controller to store configuration information to be read by the USB controller. To save cost, the memory module 26 may be omitted. Without the memory module 26, the configuration information are stored in a memory of an external device. The configuration information are transmitted through the USB interface to the USB controller so to control the communication control switch and the power source control switch etc.

It is to be noted that in above two preferred embodiments, the USB controller can be directly and electrically connected to the tuner/demodulator module under certain conditions when the output signals from the tuner/demodulator module match with that from the USB controller.

1. A USB interface circuit achieving the purpose of shared tuner and recording function of AV device includes an AV signals conversion module, a power source module, a power source control module, an IR remote control receiving module, and a tuner/demodulator module; the AV signals conversion module is electrically connected to the USB controller to convert analog or digital AV signals into digital AV signals with a matching speed rate that can be identified by the USB controller; the power switch module is electrically connected to the USB controller to receive control signals from the USB controller; the power switch module is also electrically connected to the USB interface and a power source module in a TV set or a STB so to switch between two power sources that supply power to an IR remote control receiving module, the primary control module and the tuner/demodulator module in the TV set or the STB; the USB controller is respectively and electrically connected to the AV signals conversion module and the USB interface to receive digital AV signals converted from the AV signals conversion module and transmit those digital signals to the USB interface; the USB controller is further electrically connected to the IR remote control receiving module to receive remote control signals; the USB interface is electrically connected to the USB controller and the AV signals conversion module to supply power and provide a socket for connection by an external device.

2. The USB interface circuit of claim 1, wherein the communication control switch module includes a control port, two input ports and one output port; the control port is electrically connected to the USB controller; two input ports are respectively and electrically connected to the USB controller and the primary control module in the TV set or the STB; the output port is electrically connected to the tuner/demodulator module, control signals from the USB controller or the primary control module is selected by USB controller for the tuner/demodulator module.

3. The USB interface circuit of claim 2, wherein the power switch module includes a control port, two input ports, and an output port; the control port is electrically connected to the USB controller; one input port is directly connected to the USB interface, and another input port is electrically connected to the source module in the TV set or the STB so to switch between two sources that supply power to the remote-control receiving module, the primary control module and the tuner/demodulator module in the TV set or the STB, thus to achieve the purpose of shared use of the present invention between the IR remote-control receiving module and the tuner/demodulator module no matter whether the TV set or the STB power is on or off.

4. The USB interface circuit of claim 2, wherein the power switch module includes a control port, three input ports, and one output port; the control port is electrically connected to the USB controller, one input port is directly connected to the USB interface, another input port is connected to the power source input of an external device, and another input port is electrically connected to the power source module in the TV set or the STB so to switch between two sources that supply power to the IR remote-control receiving module, the primary control module and the tuner/demodulator module in the TV set or the STB.

5. In the USB interface circuit of claim 1, a memory module is further included to electrically connect to the USB controller for storage of configuration information to be read by the USB controller.

6. In the USB interface circuit of claim 2, a memory module is further included to electrically connect to the USB controller for storage of configuration information to be read by the USB controller.

7. In the USB interface circuit of claim 3, a memory module is further included to electrically connect to the USB controller for storage of configuration information to be read by the USB controller.

8. In the USB interface circuit of claim 4, a memory module is further included to electrically connect to the USB controller for storage of configuration information to be read by the USB controller.

9. The USB interface circuit of claim 1, the USB controller can be directly and electrically connected to the tuner/demodulator module.

10. The USB interface circuit of claim 2, the USB controller can be directly and electrically connected to the tuner/demodulator module.

11. The USB interface circuit of claim 3, the USB controller can be directly and electrically connected to the tuner/demodulator module.

12. The USB interface circuit of claim 4, the USB controller can be directly and electrically connected to the tuner/demodulator module.
